(19) United States
(12) Patent Application Publication
(10) Pub. No.: US 2008/0213513 A1
(43) Pub. Date: Sep. 4, 2008

(54) Antiglare film

(75) Inventors: Hisamitsu Kameshima, Tokyo (JP); Kae Takahashi, Tokyo (JP); Yasuhiro Miyauchi, Tokyo (JP); Yu Matsuura, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/899,900

(22) Filed: Sep. 6, 2007

(30) Foreign Application Priority Data
Mar. 1, 2007 (JP) 2007-051238

(51) Int. Cl. C09K 19/00; B32B 5/16

(52) U.S. Cl. 428/1.32; 428/332

(57) ABSTRACT

The present invention includes an antiglare film including an antiglare layer which layer includes a silica particle and a binder matrix, wherein refractive index of the silica particle is 1.46-1.50, wherein the silica particle is an amorphous silica which includes an aggregate of fine silica particles, wherein average particle diameter of the silica fine particles is 0.003-0.1 μm, wherein average particle diameter of the silica particle is 1.0-3.0 μm, wherein the binder matrix is formed by curing a binder matrix curable material with ionizing radiation, and wherein the binder matrix curable material includes trifunctional acrylic monomer and tetrafunctional acrylic monomer of 80 part by weight or more based on a binder matrix forming material of 100 part by weight.

### CROSS REFERENCE

This application claims priority to Japanese application number 2007-051238, filed on Mar. 1, 2007, which is incorporated by reference.

### BACKGROUND OF THE INVENTION

1. Field of the Invention

The present invention relates to an antiglare film to be provided on the surface of a window, display etc. In particular, it relates to an antiglare film to be provided on the front surface of such displays as a liquid crystal display (LCD), cathode-ray tube (CRT) display, plasma display (PDP), organic electroluminescence display (ELD) and field effect display (FED, SED). Further, it relates to an antiglare film to be provided on the front surface of a display of a laptop PC or desktop personal computer.

2. Description of the Related Art

Displays such as a liquid crystal display, CRT display, EL display and plasma display have some problems described below from the viewpoint of visibility.

External light reflects at looking and listening.

Surface glare (scintillation) occurs at the display surface by display light from the display.

Visibility is not good caused by dazzle of display light directly coming from the display without being diffused, etc.

Visibility is also degraded by such defect as unevenness of brightness.

In order to solve such lowering or degradation of visibility, it is known to arrange an antiglare film on the front face of a display.

As an antiglare film, for example, following techniques are known:

To arrange, on the surface of a display, an antiglare film having an antiglare layer having been subjected to embossing finish.

To arrange, on the surface of a display, an antiglare film having an antiglare layer on the surface of which is formed irregularity by mixing particles in a binder matrix.

In such antiglare film, scattering phenomenon (surface diffusion) of light caused by surface irregularity is utilized.

Further, such antiglare film is also known that, by mixing particles having a refraction index different from that of a binder matrix into the binder matrix, utilizes internal scattering (internal diffusion) of light based on the difference in refraction indices of the binder matrix and particles.

In an antiglare film on the surface of which is formed irregularity through embossing finish, the surface irregularity thereof can be completely controlled. Consequently, reproducibility is good. However, when there is a defect or an adhered foreign substance on an emboss roll, endless defects occurs at the pitch of roll.

On the other hand, an antiglare film using a binder matrix and particles can be manufactured through a smaller number of processes than the antiglare film using embossing finish. Accordingly, it can be manufactured inexpensively. Therefore, various embodiments of antiglare film are known (Patent Document 1).

As for an antiglare film using a binder matrix and a particle, various technologies are disclosed, for example, the following technologies are disclosed:

A technique in which binder matrix resin, spherical particles and amorphous particles are used in combination (Patent Document 2).

A technique in which binder matrix resin and plural particles having different particle sizes are used (Patent Document 3).

A technique including surface irregularity, wherein the cross-sectional area of the concave portion is defined (Patent Document 4).

In addition, the following techniques are disclosed:

A technique wherein internal haze (cloudiness) is 1-15% and surface haze (cloudiness) is 7-30% by using internal scattering and surface scattering in combination. (Patent Document 5)

A technique wherein, while using binder resin and particles having the particle size of 0.5-5 μm, the difference in refraction indices of the resin and the particle is 0.02-0.2 (Patent Document 6).

A technique wherein, while using binder resin and particles having the particle size of 1-5 μm, the difference in refraction indices of the resin and the particle is 0.05-0.15. Further, techniques defining a solvent to be used, surface roughness etc. (Patent Document 7).

A technique wherein, using binder resin and plural types of particles, the difference in refraction indices of the resin and the particle is 0.03-0.2 (Patent Document 8).

There are also known following techniques that reduce lowering of contrast, hue variation etc. when a viewing angle is altered. In the technique, the surface haze (cloudiness) is 3 or more. Further, the difference between the haze value in the direction of normal line and the haze value in the direction of ±60° is 4 or less (Patent Document 9).

As described above, there are disclosed antiglare films of various constitutions for various purposes.

The performance required for an antiglare film differs depending on displays when it is used on the front face of a display. For example, the optimum antiglare film differs depending on the resolving power of a display, intended purpose etc. A broad range of antiglare films is required according to intended purposes.

For example, an antiglare film arranged on a front surface of a display of a laptop PC or a desktop personal computer is required to have high antiglare property and high abrasion resistant property. The purpose of the present invention is to provide an antiglare film having high antiglare property and high abrasion resistant property.
[Patent Document 1] JP-A-6-18706
[Patent Document 2] JP-A-2003-260748
[Patent Document 3] JP-A-2004-004777
[Patent Document 4] JP-A-2003-004903
[Patent Document 5] JP-A-11-305010
[Patent Document 6] JP-A-11-326608
[Patent Document 7] JP-A-2000-338310
[Patent Document 8] JP-A-2000-180611
[Patent Document 9] JP-A-11-160505

### SUMMARY OF THE INVENTION

In accordance with one embodiment of the present invention an antiglare film is disclosed comprising: a transparent electrode; and an antiglare layer including a silica particle and a binder matrix, wherein refractive index of the silica particle is 1.46-1.50, wherein the silica particle is an amorphous silica which includes an aggregate of fine silica particles, wherein average particle diameter of the silica fine particles is 0.003-0.1 μm, wherein average particle diameter of the silica particle is 1.0-3.0 μm, wherein the binder matrix is formed by curing a binder matrix curable material with ionizing radiation, wherein the binder matrix curable material includes trifunctional acrylic monomer and tetrafunctional acrylic monomer of 80 part by weight or more based on a binder matrix forming material of 100 part by weight, and wherein reflectivity of 5° angle of a surface of an antiglare layer is 0.2-1.0%.

### BRIEF DESCRIPTION OF DRAWINGS

FIG. 1 is a cross section view of an embodiment of an antiglare film of the present invention.

FIG. 2 is a drawing illustrating measurement of reflectance.

FIGS. 3 (a) and (b) are cross section views of a transmission type liquid crystal display using an embodiment of an antiglare film of the present invention.

FIG. 4 is a view of a frame format of a die coater application apparatus.

In these drawings, 1 is an antiglare film; 11 is a transparent substrate; 12 is a antiglare layer; 120 is a binder matrix; 12S is a silica particle; H is average film thickness of an antiglare layer; L1 is incident light; L2 is reflected light; 2 is a polarizing plate; 21 is a transparent substrate; 22 is a transparent substrate; 23 is a polarizing layer; 3 is a liquid crystal cell; 4 is a polarizing plate; 41 is a transparent substrate; 42 is a transparent substrate; 43 is a polarizing plate; 5 is a backlight unit; 7 is a polarizing plate unit; 30 is a die head; 31 is a piping; 32 is a tank for a coating liquid; 33 is a liquid supplying pump; and 35 is a rotary roll.

### DESCRIPTION OF THE PREFERRED EMBODIMENTS

An antiglare film of some embodiments of the present invention is described below.

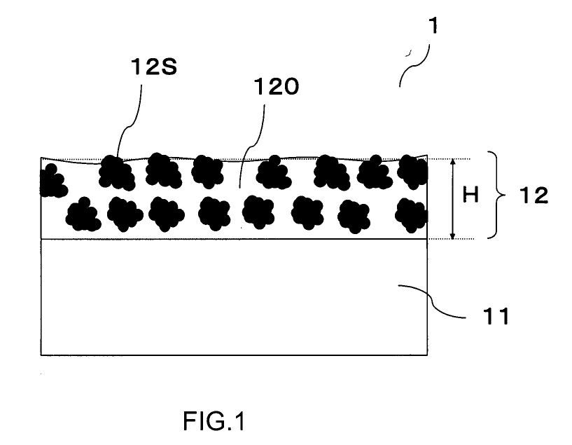

FIG. 1 shows a cross sectional view of an antiglare film of an embodiment of the present invention. As for antiglare film (1), antiglare layer (12) is formed on transparent substrate (11). Antiglare layer (12) of antiglare film (1) can include binder matrix (120) and silica particle (12S).

In some embodiments of the present invention, refractive index of silica particle (12S) is 1.46-1.50. In addition, silica particle (12S) is an amorphous silica particle which includes an aggregate of fine silica particles, wherein average particle diameter of the silica fine particle is 0.003-0.1 μm, and wherein average particle diameter of the silica particle is 1.0-3.0 μm. In addition, the binder matrix is formed by curing a binder matrix curable material with ionizing radiation, wherein the binder matrix curable material includes “trifunctional acrylic monomer and tetrafunctional acrylic monomer” of 80 part by weight or more based on a binder matrix forming material of 100 part by weight. In addition, reflectivity of 5° angle of a surface of an antiglare layer is 0.2-1.0%.

Inventors of the present invention found that an antiglare film having high abrasion resistant property can be obtained when an antiglare layer is formed using silica particle of which refractive index is 1.46-1.50. Refractive index of a silica particle depends on density of silicon oxide. The higher the density is, the higher the refractive index is. For example, as for quartz of which density is highest, refractive index of quartz is 1.55. Further, as for silica particle, the higher the density is, the higher the hardness is. When an antiglare film is formed by using silica particle of which refractive index is less than 1.46, an antiglare film having high abrasion resistant property can not be obtained because silica particle does not have enough hardness. In addition, since silica particle of which refractive index is more than 1.50 is too expensive, such silica particle is not suitable for manufacturing an antiglare film.

In addition, in the present invention, refractive index of silica can be measured according to the Becke line-detecting method (immersion method).

Further, inventor of the present invention found that an antiglare film having high antiglare property can be obtained in a case where silica particle use for an antiglare layer is an amorphous silica particle which includes an aggregate of fine silica particles, wherein average particle diameter of the silica fine particle is 0.003-0.1 μm, and wherein average particle diameter of the silica particle is 1.0-3.0 μm. As for an amorphous silica particle which silica fine particles are aggregated, there are small concaves and convexes at surface of the amorphous silica particle due to silica fine particle. By using an amorphous silica particle with such small concaves and convexes, an antiglare layer to be formed has small concaves and convex at front surface of the layer, which is reflecting a silica fine particle. Therefore, as for light incident on the antiglare layer, the antiglare layer has enough light scattering performance. Therefore, in the present invention, an antiglare film having high antiglare property can be obtained.

In some embodiments of the present invention, average particle diameter of silica fine particle which is a primary particle, that is, diameter of a primary particle is 0.003-0.1 μm. In a case where average particle diameter of a silica fine particle is less than 0.003 μm, since a silica fine particle is too small and surface of a silica particle, which includes an aggregate of fine silica particles, becomes smooth, an antiglare film to be formed can not have enough antiglare property. In a case where average particle diameter of silica fine particle is more than 0.1 μm, surface of an amorphous silica particle, which includes aggregate of fine silica particles has too big concaves and convexes, and an antiglare film to be obtained is whitened and visibility is lowered.

Further, in some embodiments of the present invention, average particle diameter of a silica particle which is a secondary particle is 1.0-3.0 μm. In a case where average particle diameter of a silica particle is less than 1.0 μm, as for light incident on an antiglare layer to be formed, an antiglare layer can not have enough light scattering performance, and therefore an antiglare having high antiglare performance can not be obtained. On the other hand, in a case where average particle diameter of a silica particle is more than 3.0 μm, an antiglare film to be obtained is whitened and visibility is lowered.

Further, more preferably, average particle diameter of a silica particle which is a secondary particle is 1.5-2.5 μm. By setting average particle diameter of a silica particle at 1.5-2.5 μm, an antiglare film having high antiglare property and enough visibility can be further obtained.

In addition, in the present invention, average particle diameter of a silica fine particle (diameter of a primary particle) can be measured by a method for measuring particle diameter distribution based on light scattering. Particle diameter of aggregated secondary particle can be measured by the same method.

In some embodiments of the present invention, a binder matrix used for an antiglare layer is formed by curing a binder matrix curable material with ionizing radiation, wherein the binder matrix curable material includes “trifunctional acrylic monomer and tetrafunctional acrylic monomer” of 80 part by weight or more based on a binder matrix forming material of 100 part by weight. Inventor of the present invention found that an antiglare film with an antiglare layer having higher abrasion resistant property can be obtained in a case where a binder matrix used for an antiglare layer is formed by curing a binder matrix curable material with ionizing radiation, wherein the binder matrix curable material includes “trifunctional acrylic monomer and tetrafunctional acrylic monomer” of 80 part by weight or more based on a binder matrix forming material of 100 part by weight.

In a case where a monofunctional acrylate monomer or a bifunctional acrylate monomer used instead of either of trifunctional acrylic monomer and tetrafunctional acrylic monomer, an antiglare layer to be formed can not have enough hardness. Further, in a case where a binder matrix curable material includes “trifunctional acrylic monomer and tetrafunctional acrylic monomer” of less than 80 part by weight based on a binder matrix forming material of 100 part by weight, it is difficult for an antiglare layer to be formed to have enough hardness.

In addition, in a case where only trifunctional acrylic monomer is used and tetrafunctional acrylic monomer is not used, defects such as streak and unevenness at a front surface of an antiglare layer to be formed is easy to occur and non-uniformity inside a front surface of an antiglare layer occurs. In addition, in a case where only tetrafunctional acrylic monomer is used and trifunctional acrylic monomer is not used, defects such as streak and unevenness at a front surface of an antiglare layer to be formed is easy to occur, non-uniformity inside a front surface of an antiglare layer occurs and curl of an antiglare film to be manufactured is easy to occur.

In addition, in some embodiments of the present invention, the mixing ratio of trifunctional acrylic monomer and tetrafunctional acrylic monomer can be selected from (1:10)-(10:1). Further, in the light of balancing high abrasion resistant property with controlling curl, more preferably, the mixing ratio of trifunctional acrylic monomer and tetrafunctional acrylic monomer is (1:3)-(3:1).

Inventors of the present invention found that, in an antiglare film with an antiglare layer including a silica particle and a binder matrix, high antiglare property is achieved in a case where reflectivity of 5° angle of a surface of an antiglare layer is 0.2-1.0%. In a case where reflectivity of 5° angle of a surface of an antiglare layer is less than 0.2%, an obtained antiglare layer is whitened. On the other hand, in a case where reflectivity of 5° angle of a surface of an antiglare layer is more than 1.0%, high antiglare property can not be achieved.

Further, more preferably, reflectivity of 5° angle of a surface of an antiglare layer is 0.4-0.8%. In a case where reflectivity of 5° angle of a surface of an antiglare layer is 0.4-0.8%, an antiglare film having higher antiglare property and no white blur can be achieved.

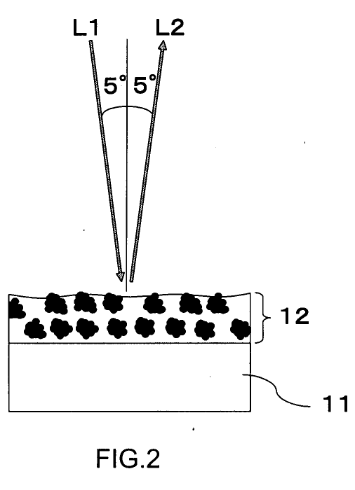

In addition, reflectivity at 5° angle means reflectivity in the direction at 5° angle from the normal line to a surface of an antiglare layer and can be measured by using a reflectivity measuring apparatus. FIG. 2 illustrates the measurement of the reflectivity at 5° angle. Incident light L1 from a direction at 5° angle from the normal line to a surface of an antiglare layer is incident on an antiglare layer. Intensity of reflected light L2 which is light reflected on an antiglare layer is measured in another direction at 5° angle from the normal line to a surface of an antiglare layer, wherein the direction of L1 is opposite to the another direction of L2. At this case, relative value of intensity of reflected light L2 is referred to as “reflectivity at 5° angle”, wherein intensity of incident light L1 is defined as 100%.

In addition, in some embodiments of the present invention, high antiglare property is achieved in a case where an amorphous silica particle, which includes an aggregate of fine silica particles is used as a silica particle and the reflectivity at 5° angle of a surface of an antiglare layer is 0.2-1.0%, more preferably 0.4-0.8%. In the present invention, an antiglare film having high antiglare property and external light reflection preventive property can be obtained in a case where an amorphous silica particle which include an aggregate of fine silica particles, concaves and convexes of small size is formed at a surface of an antiglare layer by small concaves and convexes of an amorphous silica and therefore the reflectivity at 5° angle of a surface of an antiglare layer is set at a very low value, that is, less than 1.0%, more preferably less than 0.8%.

In some embodiments of the present invention, an antiglare film having high abrasion resistant property can be obtained in a case where refractive index is 1.46-1.50 and both of trifunctional acrylic monomer and tetrafunctional acrylic monomer are used. In the present invention, an antiglare film having high abrasion resistant property can be obtained in a case where a hard enough silica having refractive index of 1.46-1.50 is used and a binder matrix is formed by using both of trifunctional acrylic monomer and tetrafunctional acrylic monomer.

An antiglare film of the present invention is preferably used for a front surface of a display of a laptop PC or a desktop PC. In a case where an antiglare film is used for a front surface of a display of a laptop PC or a desktop PC, since an operator of the PCs watches a screen of PCs for a long time from the front of the display, very high antiglare property in the front direction is required. High antiglare property can be achieved since an amorphous silica particle, which can be include an aggregate of fine silica particles is used as a silica particle and the reflectivity at 5° angle of a surface of an antiglare layer is 0.2-1.0%, more preferably 0.4-0.8%.

In addition, in a case where an antiglare film is arranged in front surface of a display of a laptop PC or a desktop PC, very high abrasion resistant property is required because an operator of PCs may scratch a front surface of a display by a sharp head of a ballpoint pen or a pencil. In the present invention, high abrasion resistant property is achieved since refractive index of silica can be 1.46-1.50 and both of trifunctional acrylic monomer and tetrafunctional acrylic monomer can be used as a binder matrix.

In addition, in the present invention, it is desirable that a silica particle which includes an aggregate of fine silica particles is covered by silicone. If a silica particle is not covered by silicone, aggregation of silica fine particles may be further developed, stability of a coating liquid can not be kept and mass productive becomes difficult due to change of average particle diameter of a silica particle with time.

In addition, in some embodiments of the present invention, it is desirable that a silica particle of 3-15 part by weight based on a binder matrix formation material of 100 part by weight is included in an antiglare layer. In a case where a silica particle of less than 3 part by weight based on a binder matrix formation material of 100 part by weight is included, high abrasion resistant property may not be achieved. In addition, in a case where a silica particle of more than 15 part by weight based on a binder matrix formation material of 100 part by weight is included, defects such as streak and unevenness at a front surface of an antiglare layer to be formed is easy to occur, non-uniformity inside a front surface of an antiglare layer may occur.

In addition, in some embodiments of the present invention, it is desirable that difference in refractive index between a silica particle and a binder matrix is equal to or less than 0.07. In a case where difference in refractive index between a silica particle and a binder matrix is more than 0.07, an antiglare layer to be formed may be whitened. Further, it is desirable that difference in refractive index between a silica particle and a binder matrix is equal to or more than 0.01, but refractive index of a silica may be equal to refractive index of a binder matrix.

In addition, in some embodiments of the present invention, refractive index of a binder matrix means refractive index of a binder matrix which a binder matrix forming material without silica particle is cured. That is, refractive index of a binder matrix means refractive index of a product which a coating liquid without a silica particle is cured. Refractive index of a binder matrix, as well as refractive index of a silica particle, can be measured according to the Becke line-detecting method (immersion method).

In addition, in the present invention, it is desirable that average film thickness H of an antiglare layer to be formed is 2-7 μm. In a case where average film thickness H of an antiglare layer to be formed is less than 2 μm, an antiglare layer to be formed may not be able to have high abrasion resistant property. On the other hand, in a case where average film thickness H of an antiglare layer to be formed is more than 7 μm, manufacturing cost becomes high and unevenness of a coated film easily occurs. In some embodiments of the present invention, an average file thickness of an antiglare layer means an average value of a film thickness of an antiglare layer having surface irregularity, that is, concaves and convexes in a surface. An average film thickness can be measured by using an electronic micrometer or a full automatic detailed configuration measurement machine.

In addition, an antiglare film can have a functional layer having a performance such as reflection preventing performance, antistatic performance, antifouling performance, electromagnetic shield performance, infrared absorbing performance, ultraviolet absorbing performance and color correcting performance. Examples of these functional layers include a reflection preventing layer, an antistatic layer, an antifouling layer, an electromagnetic shield layer, an infrared absorbing layer, an ultraviolet absorbing layer, a color correcting layer and the like. In addition, these functional layers may consist of one layer or a plural of layers. One embodiment of the functional layer is that a functional layer consisting of one layer has a plural of functions. For example, a reflection preventing layer having antifouling performance can be adopted. In addition, to improve adhesion property between a transparent substrate and an antiglare layer or between some kinds of layers, a primer layer, an adhesion layer and the like can be provided between some layers.

An antiglare film of the present invention can be used for a surface at a observer side of various displays such as a liquid crystal display (LCD), a CRT display, an organic electroluminescence display (ELD), a plasma display (PDP), surface-conduction electron-emitter display (SED), and Field Emission Display (FED).

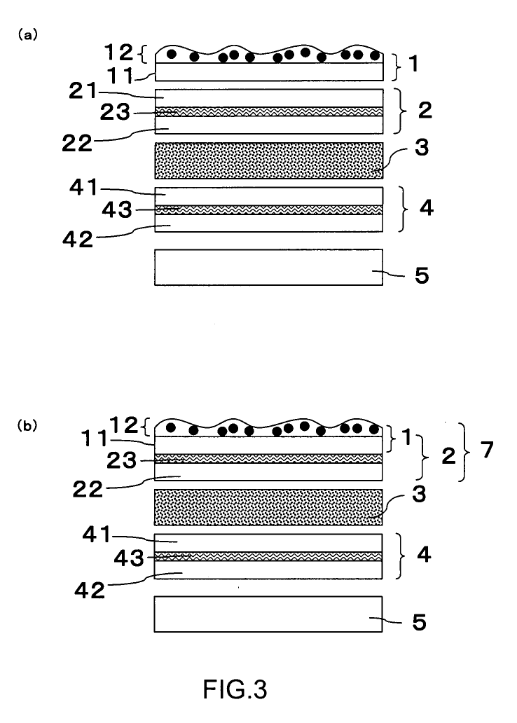

FIG. 3 is a cross-sectional view showing a transmission type liquid crystal display with the use of an antiglare film of an embodiment of the present invention. A transmission type liquid crystal display shown in FIG. 3(a) has a backlight unit (5), a polarization plate (4), a liquid crystal cell (3), a polarization plate (2) and an antiglare film (1) in this order. In this embodiment, an antiglare film (1) side is an observer side, that is, a front surface of a display.

A backlight unit (5) comprises a light source and a light diffusing plate. As for a liquid crystal cell, an electrode is provided on a transparent substrate in one side, an electrode and a color filter are provided on a transparent substrate in another side and a liquid crystal is encapsulated between both of the electrodes. As for polarization plates sandwiching a liquid crystal cell (3), polarization layers (23, 43) are between transparent substrates (21, 22, 41 and 42).

A transmission type liquid crystal display shown in FIG. 3(b) has a backlight unit (5), a polarization plate (4), a liquid crystal cell (3) and a polarization plate unit (7) which a polarization plate (2) combines with an antiglare film (1), in this order.

As for an antiglare film used for a liquid crystal display, as shown in FIG. 3(b), a polarization layer (23) can be provided on a surface of a transparent substrate (11) opposite to a surface where an antiglare layer (12) is formed, and the transparent substrate (11) can be used as a polarization plate.

A method of manufacturing an antiglare film of some embodiments of the present invention is described below.

A method of manufacturing an antiglare film can provide an antiglare layer, wherein the method includes forming a coated film by applying a coating liquid to an transparent substrate, which coating liquid includes a binder matrix forming material and a silica particle, further a solvent if necessary, and curing a binder matrix forming material with ionizing radiation, wherein the binder matrix curable material includes “trifunctional acrylic monomer and tetrafunctional acrylic monomer” of 80 part by weight or more based on a binder matrix forming material of 100 part by weight. Further, the method can include a drying process for removing a solvent included in a coated film comprising a coating liquid formed on a transparent substrate between a process of applying a coating liquid to an transparent substrate and a process of curing a binder matrix forming material.

First of all, a coating liquid is described below.

As for a silica particle which is an amorphous silica particle which includes an aggregate of fine silica particles, a known silica particle can be used, wherein refractive index of the known silica particle can be 1.46-1.50, wherein average particle diameter of a silica fine particle can be 0.003-0.1 μm and wherein average particle diameter of a silica particle can be 1.0-3.0 μm.

As for a binder matrix forming material, “trifunctional acrylic monomer and tetrafunctional acrylic monomer” of 80 wt % or more based on a binder matrix forming material is necessary to be used. Examples of “trifunctional acrylic monomer and tetrafunctional acrylic monomer” include trifunctional and tetrafunctional materials among multifunctional acrylate monomers such as acrylic acid ester and methacrylic acid ester of polyvalent alcohol, or, multifunctional urethane acrylate synthesized from diisocyanate, polyvalent alcohol and acrylic acid ester or methacrylic acid ester.

Further, other materials of less than 20 part by weight based of a binder matrix forming material of 100 part by weight can be included in a binder matrix forming material. As for a binder matrix forming material other than trifunctional acrylic monomer and tetrafunctional acrylic monomer, monofunctional acrylate monomer, bifunctional acrylate monomer, polymer and the like can be used. As polymers, vinyl resin such as vinyl acetate and the copolymer, chloroethylene and the copolymer, vinylidene chloride and the copolymer, acetal resin such as polyvinylformal and polyvinylbutyral, acrylic resin such as acryl resin and the copolymer, methacrylic resin and the copolymer, polystyrene, polyamide resin, linear polyester resin and polycarbonate resin can be used. Preferably, these polymers should have acrylate type functional group.

A coating liquid can include a solvent if necessary. As a solvent, it is necessary to use a solvent which can scatter the binder matrix forming material and the silica particle.

Further, the solvent is required to be provided with coating aptitude. For example, toluene, cyclohexanone, acetone, ketone, ethylcellosolve, ethylacetate, butylacetate, methyl isobutyl ketone, isopropanol methyl ethyl ketone, cyclohexanone, tetrahydrofuran, nitromethane, 1,4-dioxan, dioxolane, N-methylpyrrolidone, ethyl acetate, methyl acetate, dichloromethane, trichloromethane, trichloroethylene, ethylene chloride, trichloroethane, tetra chloroethane, N,N-dimethylformamide and chloroform can be used. In addition a combined solvent thereof can be used.

Among the ionizing radiation-curable material, when ultraviolet ray-curable material is used, a photopolymerization initiator is added to a coating liquid. Any photopolymerization initiator may be usable, but the use of one suitable for a material to be used is preferred. As the photopolymerization initiator, benzoin such as benzoin, benzoinmethylether, benzomethylether, benzoinisopropylether and benzylmethylketal and alkyl ethers thereof are used. The use amount of the photosensitizing agent is 0.5-20 wt %, preferably 1-5 wt % relative to the binder matrix forming material.

In a coating liquid for the present invention, to the coating liquid, other functional additives may be added. But, other functional additives must not affect transparency, light diffuseness etc. of an antiglare layer to be formed. Examples of the usable functional additive include an antistatic agent, an ultraviolet absorber, an infrared absorber, a refraction index-adjusting agent, an antifouling agent, a water repellent agent, an adhesiveness-improving agent and a curing agent. An antiglare layer to be formed can have functions such as an antistatic function, an ultraviolet absorbing function, an infrared absorbing function, an antifouling function and a water repellent function besides an antiglare function.

In the present invention, a coating liquid can be applied to a transparent substrate, and a film can be formed.

As the substrate for use in the antiglare film of the invention, glass, a plastic film etc. can be used. It suffices that the plastic film has a proper degree of transparency and mechanical strength. For example, such films as polyethylene terephthalate (PET), triacetylcellulose (TAC), diacetylcellulose, acetylcellulose butyrate, polyethylene naphthalate (PEN), cycloolefine polymer, polyimide, polyether sulfone (PES), polymethyl methacrylate (PMMA) and polycarbonate (PC) can be used.

When the antiglare film is used on the front face of a liquid crystal display etc., triacetylcellulose (TAC) is used preferably because it does not show optical anisotropy.

Further, a polarizing plate may be used as the substrate. There is no particular limitation on a polarizing plate to be used. For example, such polarizing plate can be used that has a stretched polyvinyl alcohol (PVA) added with iodine as a polarizing layer between a pair of triacetylcellulose (TAC) films which are supporting bodies of a polarizing layer. A polarizing plate composed of a TAC film and a stretched PVA added with iodine has a high polarization degree and can be used suitably for a liquid crystal display etc. In this case, an antiglare layer can be provided on one of triacetylcellulose (TAC) films.

A coating method using a roll coater, a reverse roll coater, a gravure coater, a knife coater, a bar coater or a die coater can be used as well as a well known methods in order to apply a coating liquid to a transparent substrate. Among them, a die coater which can apply a coating liquid at high speed by roll to roll method is preferably used. The solid content concentration of the coating liquid differs depending on a coating method. The solid content concentration may be around 30-70 wt % in weight ratio.

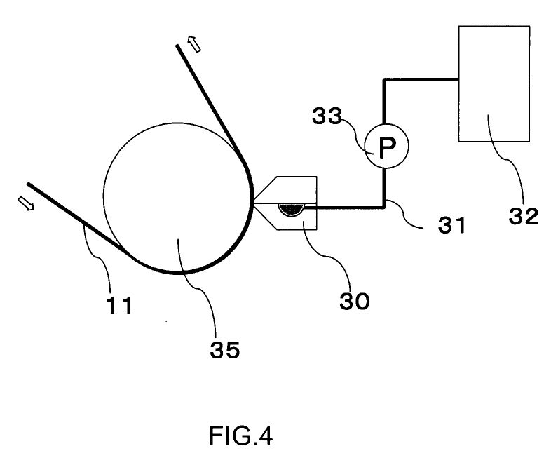

Next, a die coater application apparatus used for the present invention is described below. FIG. 4 shows a view of a frame format of a die coater application apparatus. As for a die coater application apparatus, die head 30 can be connected to tank 32 for a coating liquid by piping 31 and a coating liquid in tank 32 is sent to inside of die head 30 by liquid supplying pump 33. A coating liquid sent to die head 30 can be discharged from a slit of die head 30 and then a film is formed on transparent substrate 11. A film can be continuously formed on transparent substrate by roll to roll method by using a winding-type transparent substrate 11 and rotary roll 35.

An antiglare layer is formed by irradiating a film with ionizing radiation, wherein the film is formed by applying a coating liquid to a transparent substrate. Usable ionizing radiation includes ultraviolet rays, electron beams.

In the case of ultraviolet curing, such light source as a high-pressure mercury lamp, a low-pressure mercury lamp, an ultrahigh-pressure mercury lamp, a metal halide lamp, a carbon arc lamp and a xenon arc lamp can be utilized.

In the case of electron beam curing, electron beams emitted from various types of electron beam accelerators such as of Cockroft-Walton type, Vandegraph type, resonance transformation type, insulated core transformer type, linear type, Dynamitron type and radio-frequency type, can be utilized. The electron beam has an energy of preferably 50-1000 KeV, more preferably 100-300 KeV.

Before and after forming an antiglare layer by the curing process, a drying process may be provided. The curing and drying may be effected simultaneously. Especially, in a case where a coating liquid includes a binder matrix, a particle and a solvent, a drying process before irradiate a formed film with ionizing radiation is necessary in order to remove a solvent included in the formed film.

Examples of drying means include heating, air blowing and hot air blowing.

An antiglare film of the present invention can be formed by the above mentioned process.

An antiglare film of the above-mentioned constitution can have high antiglare property and high abrasion resistant property. An antiglare film having high antiglare property means an antiglare film, wherein, if the antiglare film is arranged on a front surface of a display, it is difficult for the antiglare film to reflect external light. An antiglare film having high abrasion resistant property means an antiglare film, wherein it is difficult for a front surface of the antiglare film to have a scratch, or, scratch formed on a front surface of the antiglare film is difficult to be observed.

### EXAMPLE

Examples are described below.

### Example 1

A triacetylcellulose film (TD-80U, manufactured by Fuji Photo Film Co., LTD.) was used as a transparent substrate. On the substrate, coating liquid A having the composition shown in Table 1 was coated with a slot die coater so that average film thickness after drying was 5 μm. In addition, coating liquid A includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight. Application of coating liquid A to a triacetylcellulose film by using a die coater application apparatus formed a coated film, and then a solvent included in a coated film was evaporated. Subsequently, the antiglare layer was cured through ultraviolet irradiation of 400 mJ/cm² using a high-pressure mercury lamp under an atmosphere of 0.03% or less of oxygen concentration, wherein some kinds of monomers were copolymerized. Thus, an antiglare film was prepared.

### Example 2

An antiglare film was prepared almost same as the antiglare film of Example 1. Coating liquid B shown in Table 1 was used instead of coating liquid A. Coating liquid B includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 1

An antiglare film was prepared almost same as the antiglare film of Example 1. Coating liquid C shown in Table 1 was used instead of coating liquid A. Coating liquid C includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 2

An antiglare film was prepared almost same as the antiglare film of Example 1. Coating liquid D shown in Table 1 was used instead of coating liquid A. Coating liquid D includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 3

An antiglare film was prepared almost same as the antiglare film of Example 1. Coating liquid E shown in Table 1 was used instead of coating liquid A. Coating liquid E includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 3

An antiglare film was prepared almost same as the antiglare film of Example 1. Coating liquid F shown in Table 2 was used instead of coating liquid A. Coating liquid F includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 4

An antiglare film was prepared almost same as the antiglare film of Example 1. Coating liquid G shown in Table 2 was used instead of coating liquid A. Coating liquid G includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 5

An antiglare film was prepared almost same as the antiglare film of Example 1. Coating liquid H shown in Table 2 was used instead of coating liquid A. Coating liquid H includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 4

An antiglare film was prepared almost same as the antiglare film of Example 1. Coating liquid I shown in Table 2 was used instead of coating liquid A. Coating liquid I includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 6

An antiglare film was prepared almost same as the antiglare film of Example 1. Coating liquid J shown in Table 2 was used instead of coating liquid A. Coating liquid J includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 5

An antiglare film was prepared almost same as the antiglare film of Example 1. Coating liquid K shown in Table 3 was used instead of coating liquid A. Coating liquid K includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 7

An antiglare film was prepared almost same as the antiglare film of Example 1. Coating liquid L shown in Table 3 was used instead of coating liquid A. Coating liquid L includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 6

An antiglare film was prepared almost same as the antiglare film of Example 1. Coating liquid M shown in Table 3 was used instead of coating liquid A. Coating liquid M includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 8

An antiglare film was prepared almost same as the antiglare film of Example 1. Coating liquid N shown in Table 3 was used instead of coating liquid A. Coating liquid N includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 7

An antiglare film was prepared almost same as the antiglare film of Example 1. Coating liquid O shown in Table 3 was used instead of coating liquid A. Coating liquid O includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Comparative Example 8

An antiglare film was prepared almost same as the antiglare film of Example 1. Coating liquid P shown in Table 4 was used instead of coating liquid A. Coating liquid P includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 9

An antiglare film was prepared almost same as the antiglare film of Example 1. Coating liquid Q shown in Table 4 was used instead of coating liquid A. Coating liquid Q includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 10

An antiglare film was prepared almost same as the antiglare film of Example 1. Coating liquid R shown in Table 4 was used instead of coating liquid A. Coating liquid R includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 11

An antiglare film was prepared almost same as the antiglare film of Example 1. Coating liquid S shown in Table 4 was used instead of coating liquid A. Coating liquid S includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

### Example 12

An antiglare film was prepared almost same as the antiglare film of Example 1. Coating liquid T shown in Table 4 was used instead of coating liquid A. Coating liquid T includes toluene as a solvent of 100 part by weight, Irgacure 184 (manufactured by Ciba Specialty Chemicals) as photopolymerization initiator of 5 part by weight and BYK-350 (manufactured by BYK-Chemie) as a leveling agent of 0.2 part by weight, same as coating liquid A.

| | | | Part | |
|---|---|---|---|---|
| | | | by | Refractive |
| | | material | weight | index |
| Coating | trifunctional | pentaerythritol triacrylate | 70 | Binder matrix |
| liquid A | acrylic | | | 1.53 |
| | monomer | | | silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 10 | |
| | | (average particle diameter of silica fine | | |
| | | particle(R1): 0.02 μm, | | |
| | | average particle diameter of silica | | |
| | | particle(R2): 2.0 μm; a product of | | |
| | | TOSOH/SILICA) | | |
| Coating | trifunctional | pentaerythritol triacrylate | 55 | Binder matrix |
| liquid B | acrylic | | | 1.53 |
| | monomer | | | Silica particle |
| | tetrafunctional | pentaerythritol tetraacrylate | 25 | 1.48 |
| | acrylic | | | |
| | monomer | | | |
| | Other acrylate | — | — | |
| | Resin | PMMA resin(MW10000, a product of | 20 | |
| | component | Nippon kayaku) | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | pentaerythritol triacrylate | 50 | Binder matrix |
| liquid C | acrylic | | | 1.53 |
| | monomer | | | Silica particle |
| | tetrafunctional | pentaerythritol tetraacrylate | 20 | 1.48 |
| | acrylic | | | |
| | monomer | | | |
| | Other acrylate | — | — | |
| | Resin | PMMA resin(MW10000, a product of | 30 | |
| | component | Nippon kayaku) | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | — | — | Binder matrix |
| liquid D | acrylic | | | 1.53 |
| | monomer | | | Silica particle |
| | tetrafunctional | pentaerythritol tetraacrylate | 70 | 1.48 |
| | acrylic | | | |
| | monomer | | | |
| | Other acrylate | diethyleneglycol | 30 | |
| | | diacrylate(bifunctional) | | |
| | Resin | — | — | |
| | component | | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | pentaerythritol triacrylate | 70 | Binder matrix |
| liquid E | acrylic | | | 1.52 |
| | monomer | | | Silica particle |
| | tetrafunctional | — | — | 1.48 |
| | acrylic | | | |
| | monomer | | | |
| | Other acrylate | diethyleneglycol | 30 | |
| | | diacrylate(bifunctional) | | |
| | Resin | — | — | |
| | component | | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | pentaerythritol triacrylate | 35 | Binder matrix |
| liquid F | acrylic | | | 1.53 |
| | monomer | | | Silica particle |
| | tetrafunctional | pentaerythritol tetraacrylate | 50 | 1.46 |
| | acrylic | | | |
| | monomer | | | |
| | Other acrylate | bisphenol A diacrylate | 15 | |
| | Resin | — | — | |
| | component | | | |
| | Silica particle | Amorphous silica (covered by silicone) | 10 | |
| | | (R1: 0.02 μm, R2: 2.0 μm, low density; a | | |
| | | product of TOSOH/SILICA) | | |
| Coating | trifunctional | pentaerythritol triacrylate | 10 | Binder matrix |
| liquid G | acrylic | | | 1.55 |
| | monomer | | | Silica particle |
| | tetrafunctional | pentaerythritol tetraacrylate | 70 | 1.46 |
| | acrylic | | | |
| | monomer | | | |
| | Other acrylate | bisphenol A diacrylate | 20 | |
| | Resin | — | — | |
| | component | | | |
| | Silica particle | Amorphous silica (covered by silicone) | 10 | |
| | | (R1: 0.02 μm, R2: 2.0 μm, low density; a | | |
| | | product of TOSOH/SILICA) | | |
| Coating | trifunctional | pentaerythritol triacrylate | 70 | Binder matrix |
| liquid H | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 15 | |
| | | (R1: 0.02 μm, R2: 1.5 μm, a product of | | |
| | | TOSOH/SILICA) | | |
| Coating | trifunctional | pentaerythritol triacrylate | 70 | Binder matrix |
| liquid I | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 20 | |
| | | (R1: 0.02 μm, R2: 1.0 μm; a product of | | |
| | | TOSOH/SILICA) | | |
| Coating | trifunctional | pentaerythritol triacrylate | 70 | Binder matrix |
| liquid J | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 8 | |
| | | (R1: 0.02 μm, R2: 2.5 μm; a product of | | |
| | | TOSOH/SILICA) | | |
| Coating | trifunctional | pentaerythritol triacrylate | 70 | Binder matrix |
| liquid K | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 6 | |
| | | (R1: 0.02 μm, R2: 3.5 μm; a product of | | |
| | | TOSOH/SILICA) | | |
| Coating | trifunctional | pentaerythritol triacrylate | 70 | Binder matrix |
| liquid L | acrylic | | | 1.53 |
| | monomer | | | Silica particle |
| | tetrafunctional | pentaerythritol tetraacrylate | 30 | 1.46 |
| | acrylic | | | |
| | monomer | | | |
| | Other acrylate | — | — | |
| | Resin | — | — | |
| | component | | | |
| | Silica particle | Amorphous silica (covered by silicone) | 10 | |
| | | (R1: 0.02 μm, R2: 2.0 μm, low density; a | | |
| | | poroduct of TOSOH/SILICA) | | |
| Coating | trifunctional | pentaerythritol triacrylate | 70 | Binder matrix |
| liquid M | acrylic | | | 1.53 |
| | monomer | | | Silica particle |
| | tetrafunctional | pentaerythritol tetraacrylate | 30 | 1.44 |
| | acrylic | | | |
| | monomer | | | |
| | Other acrylate | — | — | |
| | Resin | — | — | |
| | component | | | |
| | Silica particle | Amorphous silica (covered by silicone) | 10 | |
| | | (R1: 0.02 μm, R2: 2.0 μm, low density; a | | |
| | | product of TOSOH/SILICA) | | |
| Coating | trifunctional | pentaerythritol triacrylate | 70 | Binder matrix |
| liquid N | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (not covered by | 10 | |
| | | silicone) | | |
| | | (R1: 0.02 μm, R2: 2.0 μm; a product of | | |
| | | TOSOH/SILICA) | | |
| Coating | trifunctional | pentaerythritol triacrylate | 100 | Binder matrix |
| liquid O | acrylic | | | 1.52 |
| | monomer | | | Silica particle |
| | tetrafunctional | — | — | 1.48 |
| | acrylic | | | |
| | monomer | | | |
| | Other acrylate | — | — | |
| | Resin | — | — | |
| | component | | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | — | — | Binder matrix |
| liquid P | acrylic | | | 1.53 |
| | monomer | | | Silica particle |
| | tetrafunctional | pentaerythritol tetraacrylate | 100 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 10 | |
| | | (R1: 0.02 μm, R2: 2.0 μm; a product of | | |
| | | TOSOH/SILICA) | | |
| Coating | trifunctional | pentaerythritol triacrylate | 70 | Binder matrix |
| liquid Q | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 7 | |
| | | (R1: 0.02 μm, R2: 2.0 μm; a product of | | |
| | | TOSOH/SILICA) | | |
| Coating | trifunctional | pentaerythritol triacrylate | 70 | Binder matrix |
| liquid R | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 13 | |
| | | (R1: 0.02 μm, R2: 2.0 μm; a product of | | |
| | | TOSOH/SILICA) | | |
| Coating | trifunctional | pentaerythritol triacrylate | 70 | Binder matrix |
| liquid S | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 7 | |
| | | (R1: 0.02 μm, R2: 3.0 μm; a product of | | |
| | | TOSOH/SILICA) | | |
| Coating | trifunctional | pentaerythritol triacrylate | 70 | Binder matrix |
| liquid T | acrylic | | | 1.53 |
| | monomer | | | Silica particle |
| | tetrafunctional | pentaerythritol tetraacrylate | 30 | 1.48 |
| | acrylic | | | |
| | monomer | | | |
| | Other acrylate | — | — | |
| | Resin | — | — | |
| | component | | | |
| | Silica particle | Amorphous silica (covered by silicone) | 24 | |
| | | (R1: 0.02 μm, R2: 1.0 μm; a product of | | |
| | | TOSOH/SILICA) | | |

### <Evaluation>

Reflectivity of 5° angle, glare level by reflection of external light, white blur, abrasion resistant property, curl and evenness inside a surface of a coated film of antiglare films obtained in Examples and Comparative Examples were evaluated. Evaluation results are shown in Table 5.

### <Method of Measuring>

Method of Measuring Reflectivity of 5° Angle

As for an antiglare film, a surface of triacetylcellulose where an antiglare layer was not formed was coated by using a matte-black spray. Subsequently, “reflectivity of 5° angle” of a front surface of an antiglare layer was measured by using a reflectivity measuring apparatus (U-4000(integrating-sphere type, measuring wavelength 550 nm); a product of Hitachi High-Technologies Corporation).

### <Evaluation Method>

Method of Evaluating Antiglare Property (External Light Preventive Property)

Respective antiglare films obtained in Examples and Comparative Examples were laminated to respective black plastic plates and, in that state, the reflection of fluorescent light at a part of the films was evaluated visually. The judgment standard is shown below.
⊚: reflection is not recognized at all.
◯: reflection is recognized a little and the reflection is not outstanding.
x: reflection is recognized and the reflection is outstanding.

Method of Evaluating Abrasion Resistant Property

A surface of an antiglare layer of an antiglare film obtained in Examples and Comparative Examples were scrubbed by a steel wool (# 0000) wherein the steel wool was reciprocated 10 times and the steel wool was under 250 g/cm² load. Scratches in a surface of an antiglare layer were evaluated visually.
⊚: scratch is not recognized at all.
◯: scratch is recognized a little and the scratch is not outstanding.
x: many scratches are recognized.

Method of Evaluating Whitening Level (White Blur)

Respective antiglare films obtained in Examples and Comparative Examples were laminated to respective black plastic plates and, in that state, the reflection of external light such as fluorescent light at a part of the films was evaluated visually. The judgment standard is shown below.
⊚: As for a part other than reflection light, white blur is not observed as a whole.
◯: white blur is observed a little and the white blur is not outstanding.
x: white blur is observed as a whole and it is not impossible to use the antiglare film.

Method of Evaluating Curl

Antiglare films of Examples and Comparative Examples were cut so that the cut films had a square shape of 10 cm×10 cm. Subsequently, while one side among four sides was held down on a desk by a metal ruler, it was measured how height another side which was opposite to the one side was raised from a height of the desk. The judgment standard is shown below.
⊚: The another side is raised less than 2 cm.
x: The another side is raised more than or equal to 2 cm.

Method of Evaluating Roughness Inside a Surface of an Antiglare Film

Antiglare films of Examples and Comparative Examples were cut so that the cut films had a square shape of 50 cm×50 cm. Subsequently, transmission light and reflection light were observed visually and roughness inside a surface of an antiglare film was evaluated.
⊚: roughness is good (flat).
◯: streak and roughness are observed and are not outstanding.
x: streak and roughness are observed and it is impossible to use the antiglare film.

| | | Reflectivity | | Abrasion | Whitening | | Roughness |
|---|---|---|---|---|---|---|---|
| | Coating | of 5° | Antiglare | resistant | (white | | inside a |
| | liquid | angle | property | property | blur) | curl | surface |
| Example 1 | Coating | 0.6% | ⊚ | ⊚ | ⊚ | ⊚ | ⊚ |
| | liquid A | | | | | | |
| Example 2 | Coating | 0.6% | ⊚ | ⊚ | ⊚ | ⊚ | ⊚ |
| | liquid B | | | | | | |
| Comparative | Coating | 0.6% | ⊚ | X | ⊚ | ⊚ | ⊚ |
| Example 1 | liquid C | | | | | | |
| Comparative | Coating | 0.6% | ⊚ | X | ⊚ | ⊚ | ⊚ |
| Example 2 | liquid D | | | | | | |
| Comparative | Coating | 0.5% | ⊚ | X | ⊚ | ⊚ | ⊚ |
| Example 3 | liquid E | | | | | | |
| Example 3 | Coating | 0.4% | ⊚ | ⊚ | ⊚ | ⊚ | ⊚ |
| | liquid F | | | | | | |
| Example 4 | Coating | 0.3% | ⊚ | ⊚ | ◯ | ⊚ | ⊚ |
| | liquid G | | | | | | |
| Example 5 | Coating | 0.8% | ⊚ | ⊚ | ⊚ | ⊚ | ⊚ |
| | liquid H | | | | | | |
| Comparative | Coating | 1.1% | X | ⊚ | ⊚ | ⊚ | ⊚ |
| Example 4 | liquid I | | | | | | |
| Example 6 | Coating | 0.4% | ⊚ | ⊚ | ⊚ | ⊚ | ⊚ |
| | liquid J | | | | | | |
| Comparative | Coating | 0.2% | ⊚ | ⊚ | X | ⊚ | ⊚ |
| Example 5 | liquid K | | | | | | |
| Example 7 | Coating | 0.6% | ⊚ | ⊚ | ⊚ | ⊚ | ⊚ |
| | liquid L | | | | | | |
| Comparative | Coating | 0.4% | ⊚ | X | ⊚ | ⊚ | ⊚ |
| Example 6 | liquid M | | | | | | |
| Example 8 | Coating | 0.6% | ⊚ | ⊚ | ◯ | ⊚ | ◯ |
| | liquid N | | | | | | |
| Comparative | Coating | 0.5% | ⊚ | ⊚ | ⊚ | ⊚ | X |
| Example 7 | liquid O | | | | | | |
| Comparative | Coating | 0.6% | ⊚ | ⊚ | ⊚ | X | X |
| Example 8 | liquid P | | | | | | |
| Example 9 | Coating | 1.0% | ◯ | ⊚ | ⊚ | ⊚ | ⊚ |
| | liquid Q | | | | | | |
| Example 10 | Coating | 0.2% | ⊚ | ⊚ | ◯ | ⊚ | ⊚ |
| | liquid R | | | | | | |
| Example 11 | Coating | 0.4% | ⊚ | ⊚ | ◯ | ⊚ | ⊚ |
| | liquid S | | | | | | |
| Example 12 | Coating | 0.9% | ◯ | ⊚ | ⊚ | ⊚ | ◯ |
| | liquid T | | | | | | |

As shown in Example 1-11, an antiglare film could be provided, wherein refractive index of the silica particle was 1.46-1.50, wherein the silica particle was an amorphous silica which silica fine particles were aggregated, wherein average particle diameter of the silica fine particle was 0.003-0.1 μm, wherein average particle diameter of the silica particle was 1.0-3.0 μm, wherein the binder matrix was formed by curing a binder matrix curable material with ionizing radiation, wherein the binder matrix curable material included trifunctional acrylic monomer and tetrafunctional acrylic monomer of 80 part by weight or more based on a binder matrix forming material of 100 part by weight, and wherein reflectivity of 5° angle of a surface of an antiglare layer was 0.2-1.0%.

As shown in Comparative Example 1, in a case where content of a mixture of trifunctional acrylic monomer and tetrafunctional acrylic monomer was less than 80% based on total content of a binder matrix forming material, abrasion resistant property became worse.

As shown in Comparative Example 2, in a case where trifunctional acrylic monomer was not included in a binder matrix forming material, abrasion resistant property became worse.

As shown in Comparative Example 3, in a case where tetrafunctional acrylic monomer was not included in a binder matrix forming material, abrasion resistant property became worse.

As shown in Comparative Example 4, in a case where reflectivity of 5° angle was more than 1.0%, antiglare property became worse.

As shown in Comparative Example 5, in a case where average particle diameter of a silica particle was more than 3.0 μm, white blur become outstanding and visibility became worse.

As shown in Comparative Example 6, in a case where refractive index of a silica particle was less than 1.46, abrasion resistant property became worse.

As shown in Comparative Example 7, in a case where only trifunctional acrylic monomer was used, roughness inside a surface of an antiglare film became worse and visibility became worse.

As shown in Comparative Example 8, in a case where only trifunctional acrylic monomer was used, roughness inside a surface of an antiglare film became worse and visibility became worse. Further, curl level of a manufactured antiglare film was too big to suit for next process.

What is claimed is:

1. An antiglare film comprising:
a transparent substrate; and
an antiglare layer formed on the transparent substrate, the layer includes a silica particle and a binder matrix,
wherein refractive index of the silica particle is 1.46-1.50,
wherein the silica particle is an amorphous silica which includes an aggregate of fine silica particles,
wherein average particle diameter of the silica fine particles is 0.003-0.1 μm,
wherein average particle diameter of the silica particle is 1.0-3.0 μm,
wherein the binder matrix is formed by curing a binder matrix curable material with ionizing radiation, wherein the binder matrix curable material includes trifunctional acrylic monomer and tetrafunctional acrylic monomer of 80 part by weight or more based on a binder matrix forming material of 100 part by weight, and
wherein reflectivity of 5° angle of a surface of the antiglare layer is 0.2-1.0%.

2. The antiglare film according to claim 1,
wherein average particle diameter of the silica particle is 1.5-2.5 μm.

3. The antiglare film according to claim 1,
wherein reflectivity of 5° angle of a surface of the antiglare layer is 0.4-0.8%.

4. The antiglare film according to claim 1,
wherein the silica particle is covered by silicone.

5. The antiglare film according to claim 1,
wherein content of the silica particle is 3-15 part by weight based on a binder matrix forming material of 100 part by weight.

6. The antiglare film according to claim 1,
wherein difference in refractive index between the silica particle and a binder matrix is equal to or less than 0.07.

7. The antiglare film according to claim 1,
wherein the substrate is a triacetylcellulose film.

8. An antiglare film comprising:
a transparent substrate; and
an antiglare layer formed on the transparent substrate, which layer includes a silica particle and a binder matrix,
wherein refractive index of the silica particle is 1.46-1.50,
wherein the silica particle is an amorphous silica which includes an aggregate of fine silica particles,
wherein average particle diameter of the silica fine particles is 0.003-0.1 μm,
wherein average particle diameter of the silica particle is 1.0-3.0 μm,
wherein the binder matrix includes a copolymer comprising trifunctional acrylic monomer and tetrafunctional acrylic monomer of 80 part by weight or more based on a binder matrix forming material of 100 part by weight, and
wherein reflectivity of 5° angle of a surface of the antiglare layer is 0.2-1.0%.

9. A liquid crystal display comprising:
an antiglare film according to claim 1;
a polarizing plate;
a liquid crystal cell;
a polarizing plate; and
a backlight unit, in this order.
